(19) United States
(12) Patent Application Publication
(10) Pub. No.: US 2005/0275370 A1
(43) Pub. Date: Dec. 15, 2005

(54) Fuse for lithium-ion cell and lithium-ion cell including the fuse

(76) Inventor: Youn Gu Kim, Cheonan-si (KR)

Correspondence Address: CHRISTIE, PARKER & HALE, LLP, PO BOX 7068, PASADENA, CA, 91109-7068, US

(21) Appl. No.: 11/140,470

(22) Filed: May 27, 2005

(30) Foreign Application Priority Data
May 31, 2004 (KR) 2004-0039168

(51) Int. Cl. H02J 7/00

(52) U.S. Cl. 320/107

(57) ABSTRACT

A fuse device for a lithium-ion battery and a lithium-ion battery using the fuse device. The fuse device includes a weak circuit portion within a conductive pattern located on a circuit board between an external input/output port and a bare cell. Instead of a conventional current fuse, a pattern of the circuit board is used as an overvoltage protection member. With a circuit board pattern instead of a conventional fuse, it is possible to utilize the maximum battery capacity. Further, a lead-free pattern can be used

### CROSS-REFERENCE TO RELATED APPLICATION

This application claims the priority of Korean Patent Application No. 2004-0039168, filed on May 31, 2004, in the Korean Intellectual Property Office, the disclosure of which is incorporated herein in its entirety by reference.

### BACKGROUND OF THE INVENTION

1. Field of the Invention

The present invention relates to overvoltage protection for a battery and, more particularly, to a fuse device for a lithium-ion battery using a pattern on a circuit board, instead of a current fuse, as an overvoltage protection member.

2. Description of Related Art

As many kinds of portable and mobile electronic devices are developed and miniaturized, there is a need for a high energy density secondary battery for miniaturized and compact electronic devices that is also environment friendly.

Conventionally, various kinds of secondary batteries such as lead acid batteries, nickel cadmium batteries, and nickel hydride batteries have been used. However, lithium-ion batteries best satisfy the criteria of being high energy while compact and environment friendly. Lithium-ion batteries include a positive electrode made from a lithium oxide and a negative electrode made of carbon. The lithium-ion battery has high energy storage density, light weight, and a high operating voltage. In addition, in the lithium-ion battery, there is almost no loss of electrode plate when lithium ions pass from the positive electrode through an intermediate material or electrolyte into the carbon lattices of the negative electrode. Therefore, the lithium-ion battery is conservable and has a long life.

The lithium-ion battery was developed during the 1990s. Since then, due to the high energy storage density and the light weight of the lithium-ion battery, conventional secondary batteries have been rapidly replaced with the lithium-ion battery. Recently, the lithium-ion battery has been widely used for personal computers, camcorders, cellular phones, portable CD players, and portable wireless electronic devices such as a personal data assistant or PDA. However, the use of the lithium-ion battery is still limited to expensive products. In addition, lithium-ion battery requires a particular protection circuit for its safety. Therefore, a lot of effort has been concentrated on safety and performance of the lithium-ion battery.

FIG. 1 is a block diagram showing an example of a conventional charge/discharge controller 900 for a lithium-ion battery. The conventional charge/discharge controller 900 is part of a protection circuit board 1000. One electrode of a battery 6 is connected to a positive input/output port 1. A charge control switch 4 and a discharge control switch 5 are located between a negative inpuvoutput port 2 and another electrode of the battery 6. The discharge control switch 5 and the charge control switch 4 together form part of the charge/discharge controller 900. The charge/discharge controller 900 also includes a protection circuit controller 3 for controlling the charge and discharge control switches 4, 5.

When the battery 6, also referred to as a bare cell, is in a charge mode, the charge/discharge controller 900 controls the charge control switch 4 to charge the battery 6. When the battery 6 is in a discharge mode, the charge/discharge controller 900 controls the discharge control switch 5 to discharge the battery 6.

If the chemical composition of the battery 6 becomes unstable, the lithium-ion battery may enter a state of over-charge, over-discharge, or over-current. As a result, problems such as performance deterioration, solution leakage, overheating, smoking, fire, and rupture may occur in the lithium-ion battery. In order to protect the battery 6, a protective circuit is built in the protection circuit controller 3. Therefore, the protection circuit controller 3 can protect the battery 6 against over-charge, over-discharge, and over-current during charging and discharging of the battery 6.

However, most of the conventional protection circuit boards 1000 cannot protect the battery 6 against overvoltage. Overvoltage protection is the type of protection that prevents a signal from being received if the voltage exceeds a certain limit. This helps prevent an electrical device from being overloaded and destroyed. If the overvoltage is generated due to a user's careless use in a nonstandard condition or misuse of a nonstandard charger, components such as ICs of the protection circuit board 1000 may catch on fire, rupture, be damaged, or malfunction thus compromising the safety of the battery 6.

Referring now to FIG. 2, in order to solve the problems resulting from overvoltage, a current fuse 7 may be additionally located between the positive input/output port 1 and one of the electrodes of the battery 6. A conventional protection circuit board 2000 for the lithium-ion battery 6 includes a charge/discharge controller 1900. The charge/discharge controller 1900 includes the current fuse 7. In this conventional protection circuit board 2000, the current fuse 7 is located between the positive input/output port 1 and one electrode of the battery 6.

The charge/discharge controller 1900 includes the charge control switch 4 and the discharge control switch 5 that are located between the negative input/output port 2 and the other electrode of the battery 6. The charge/discharge controller 1900 also includes the protection circuit controller 3 for controlling the charge and discharge control switches 4 and 5. When the battery 6 is in a charge mode, the charge/discharge controller 1900 controls the charge control switch 4 to charge the battery 6. When the battery 6 is in a discharge mode, the charge/discharge controller 900 controls the discharge control switch 5 to discharge the battery 6.

In order to protect the battery 6 from overvoltage, the charge/discharge controller 1900 controls the charge control switch 4 to block the overcharge when the overvoltage is less than a predetermined voltage. On the other hand, the charge/discharge controller 1900 may protect overcharge by breaking the current fuse 7 when the overvoltage is more than this predetermined voltage. The charge control switch 4 blocks the overvoltage by using the characteristics of an IC.

In the conventional charge/discharge controller 1900 for the battery 6, because there is an additional current fuse 7 used as an overvoltage protection member, the production cost increases by the price of the current fuse 7.

In addition, in the conventional charge/discharge controller 1900 for the battery 6, because the current fuse 7 has a relatively high internal resistance of 13 ohms or more, it is impossible to utilize the maximum battery capacity due to current consumption of the current fuse 7.

In addition, in the conventional charge/discharge controller 1900 for the battery 6, since the current fuse 7 contains lead components, it is difficult to satisfy the relevant environmental protection regulations.

### SUMMARY OF THE INVENTION

In order to solve the problems associated with conventional current fuses, the present invention provides a fuse device for a lithium-ion battery using a typical conducive pattern of a circuit board, such as a printed circuit board, as an overvoltage protection member instead of a current fuse. Integrating the fuse device into an printed circuit board reduces production cost, and helps utilize maximum battery capacity by using the relatively low internal resistance of the conductive pattern. Further, a lead-free pattern may be used that complies with environmental protection regulations.

Embodiments of the present invention also provide a lithium-ion battery using the fuse device.

According to one aspect of the present invention, a fuse device for a lithium-ion battery is described that includes a weak circuit portion in a conductive pattern disposed on a circuit board between an external input/output port and a bare cell.

In one embodiment, the weak circuit portion may be a narrowed or pinched portion or a portion made from a material different from the rest of the conductive pattern. In addition, the weak circuit portion may be a thin portion of the conductive pattern. The weak circuit portion may be a portion of the conductive pattern with a high degree of patterning and variation density, such as a step portion or a repeated step portion. Because heat generation concentrates on the weak circuit portion, the weak circuit portion can be used as a fuse device.

According to another aspect of the present invention, a lithium-ion battery including the aforementioned fuse device is provided in the form of a bare cell connected to the circuit board including the weak circuit patter.

### BRIEF DESCRIPTION OF THE DRAWINGS

FIG. 1 is a block diagram showing an example of a conventional charge/discharge controller for a lithium-ion battery.

FIG. 2 is a block diagram showing another example of a conventional charge/discharge controller for a lithium-ion battery.

FIG. 3 is a block diagram showing a comparative device.

FIG. 4 is a block diagram showing a fuse device for a lithium-ion battery according to a first embodiment of the present invention.

FIG. 5 is a block diagram showing a fuse device for a lithium-ion battery according to a second embodiment of the present invention.

FIG. 6 is a block diagram showing a fuse device for a lithium-ion battery according to a third embodiment of the present invention.

FIG. 7 is a side view of a lithium-ion battery according to an embodiment of the present invention.

FIG. 8 is a block diagram showing an example of a fuse device for a lithium-ion battery according to one of the embodiments of the present invention used in a charge/discharge controller for a lithium-ion battery.

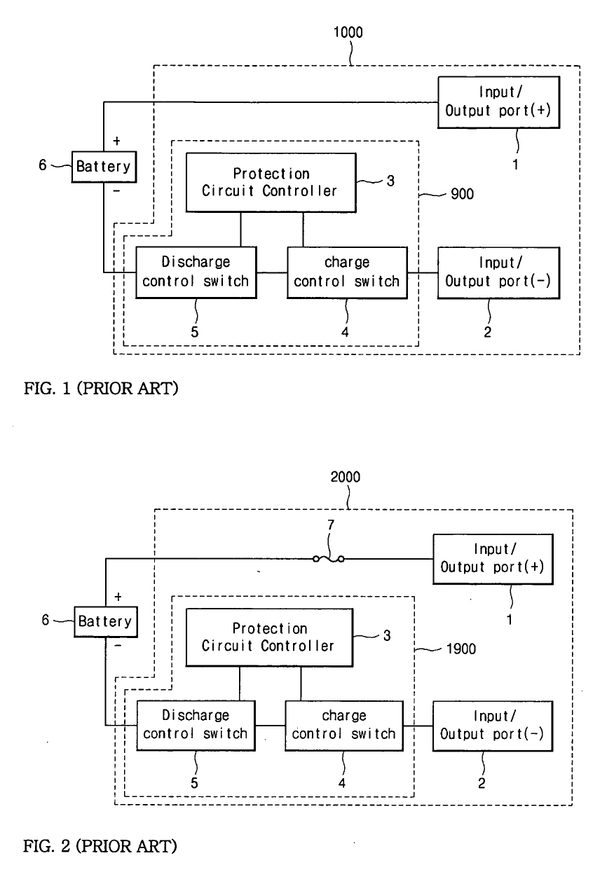

### DETAILED DESCRIPTION

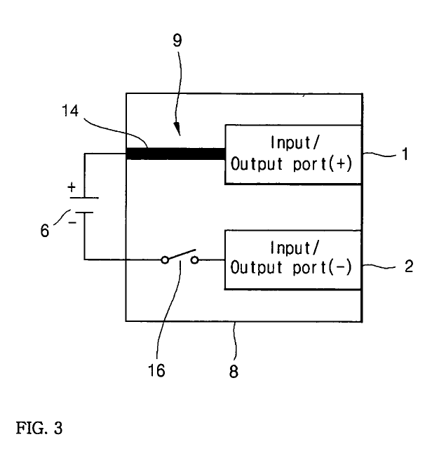

FIG. 3 is a block diagram showing a comparative example. A conductive pattern 14 couples a positive input/output port 1 to a positive terminal of a battery 6. A negative terminal of the battery 6 is coupled to a negative input/output port 2 through a switch 16. The comparative example has a pattern 9, on a circuit board 8, that has a uniform width and a straight line form. The pattern 9 is part of the conductive pattern 14 but is not differentiated from the conductive pattern 14. The pattern 9 has no weak circuit portions vulnerable to overvoltage and cannot function as a fuse.

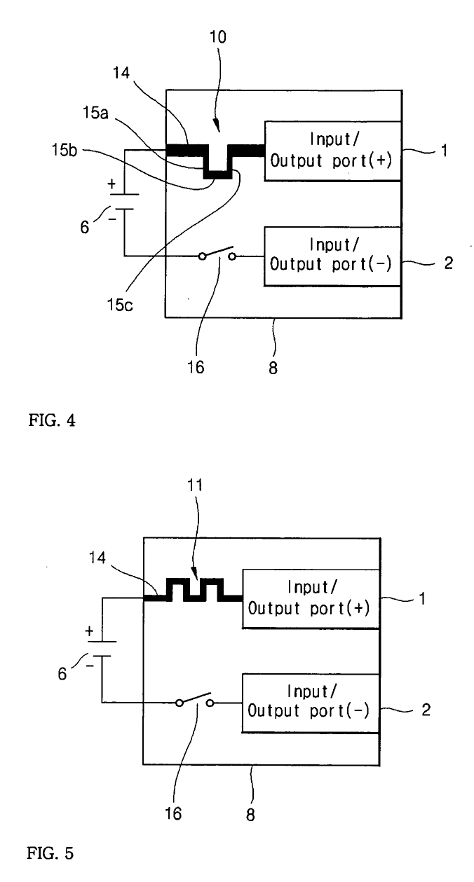

FIG. 4 is a block diagram showing a fuse device for a lithium-ion battery according to a first embodiment of the present invention. The fuse device is formed with a weak pattern 10, as a part of a conductive pattern 14 on a circuit board 8 coupling a positive input/output port 1 and a positive terminal of a battery 6. The weak pattern 10 of the fuse device has a portion shaped like step or a step portion. This shape may also be explained as being similar to a rect function or a rectangular pulse. The weak portion 10 may include one or more narrowed portions 15a, 15b, 15c. Negative input/output port 2 is coupled to the negative terminal of the battery 6 through a switch 16.

When an overvoltage exceeding a predetermined voltage is applied to the positive input/output port 1, for example due to careless use in a nonstandard condition or misuse of a nonstandard charger, a current passes through the weak pattern 10 on the circuit board 8 connecting the positive input/output port 1 and the battery 6.

Because the weak pattern 10 formed on the circuit board 8 has a step portion, ohmic heat generated by the current increases the temperature of the weak pattern 10. When overvoltage is applied, the weak pattern 10 can be disconnected by the generated heat, much like a current fuse. Disconnection of the weak pattern 10 blocks the current and prevents overvoltage from being applied to the battery 6.

FIG. 5 is a block diagram showing a fuse device for a lithium-ion battery according to a second embodiment of the present invention. The basic parts shown in FIG. 5 are similar to those shown in FIG. 4. The fuse device is formed with a weak pattern 11 on a circuit board 8 coupling a positive input/output port 1 and a battery 6. The weak pattern 11 of the fuse device has a repeated step portion.

When an overvoltage more than a predetermined voltage is applied to the positive input/output port 1, a current passes though the weak pattern 11 coupling the positive input/output port 1 to the battery 6. Because the weak pattern 11 formed on the circuit board 8 has the undulating portion, the weak pattern 11 is more vulnerable to overvoltage than the weak pattern 10 of the first embodiment. When overvoltage is applied, the weak pattern 11 can be disconnected similar to the weak pattern 10 of the first embodiment. Disconnecting the weak pattern 11, blocks the current and prevents application of the overvoltage to the battery 6.

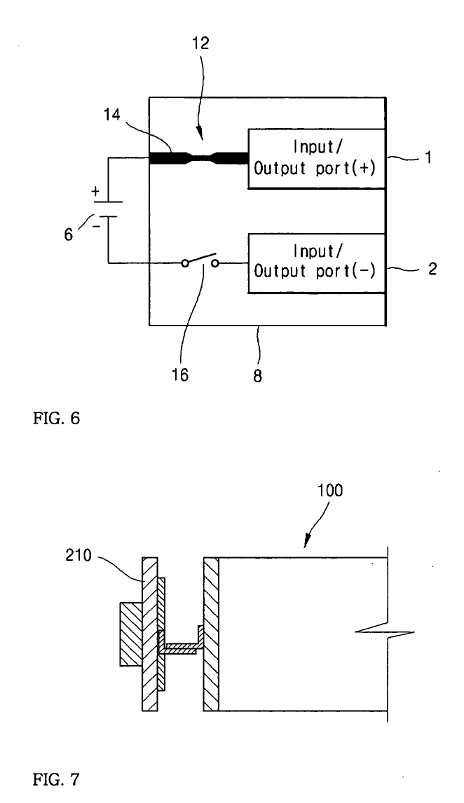

FIG. 6 is a block diagram showing a fuse device for a lithium-ion battery according to a third embodiment of the present invention. The basic parts shown in FIG. 6 are similar to those shown in FIGS. 4 and 5. As shown in FIG. 6, the fuse device is formed with a weak pattern 12 on a circuit board 8 coupling a positive input/output port 1 and a battery 6. The weak pattern 12 of the fuse device has a pinched or narrowing portion.

When an overvoltage more than a predetermined voltage is applied to the positive input/output port 1, a current passes though the weak pattern 12 on the circuit board 8 coupling the positive input/output port 1 to the battery 6.

Because the weak pattern 12 formed on the circuit board 8 has the pinched portion, the weak pattern 12 is more vulnerable to overvoltage than the weak pattern of the first embodiment. When overvoltage is applied, the weak pattern 12 can be disconnected similar to the weak patterns 10 and 11 of the first and second embodiments. By disconnection of the weak pattern 12, the current is blocked to prevent overvoltage from being applied to the battery 6.

In the first to third embodiments, in order to function as a fuse, the weak patterns 10, 11, 12 have the step, repeated step, and pinched portions, respectively. In addition, as the printed circuit board technology is further developed, the same effect can be achieved by forming the weak circuit portion with a different material or a different thickness during the printed circuit board forming process. For example, a main pattern may be formed from copper while a weak circuit portion is formed from a metal having a high specific resistance or from a heat-vulnerable metal or alloy.

According to an experiment, the pattern 9 of FIG. 3 having a width of 1.4 mm and maximum current tolerance of 2 A managed to act as a fuse, i.e. was cut at an applied voltage above 50V. The pattern 9 of FIG. 3 having a width of 1.2 mm and a maximum current tolerance of 2A was cut at an applied voltage above 40V. But, a voltage of above 40V was also applied to the two pieces producing a maximum current of 2 A. An appropriate and adoptable fuse should function at an applied voltage of at least 32V and a maximum current of 2 A. So, pattern 9, a straight line having a width of 1.4 mm or 1.2 mm, cannot be used as a fuse because unduly high voltages of 40V and 50V do not create sufficiently high heat in this portion to cause it to yield and protect the battery.

The weak pattern 10 with a step portion having a width of about 0.6 mm, shown in FIG. 4, can be used as a fuse at an applied voltage of 28V, producing a maximum current of 2 A, or at a lower voltage. The weak pattern 11 with a repeated step portion having a width of about 0.6mm, shown in FIG. 5, can be used as a fuse at an applied voltage of 27V, producing a maximum current of 2 A, or at a lower voltage. The weak pattern 12 with a pinched portion having a width of about 0.6 mm, shown in FIG. 6, can be used as a fuse at an applied voltage of 30V, producing a maximum current of 2 A, or at a lower voltage.

FIG. 7 is a side view of a lithium-ion battery according to an embodiment of the present invention. The lithium-ion battery may include the fuse device 10, 11, 12 according to the aforementioned embodiments of the present invention. In this figure, a protection circuit board 210 is assembled to a bare cell 100. Although the fuse device is not shown, the fuse device would have a weak pattern located as a portion of conductive pattern on the protection circuit board 210. The battery having the associated construction is well known to those of ordinary skill in the art of a lithium-ion secondary battery. A hard pack battery can be formed by welding the protection circuit board 210 and the electrode ports of the bare cell 100 with an electrode tap. The gap between the protection circuit board 210 and the electrode ports of the bare cell 100 may be filled with a hot melt resin (not shown).

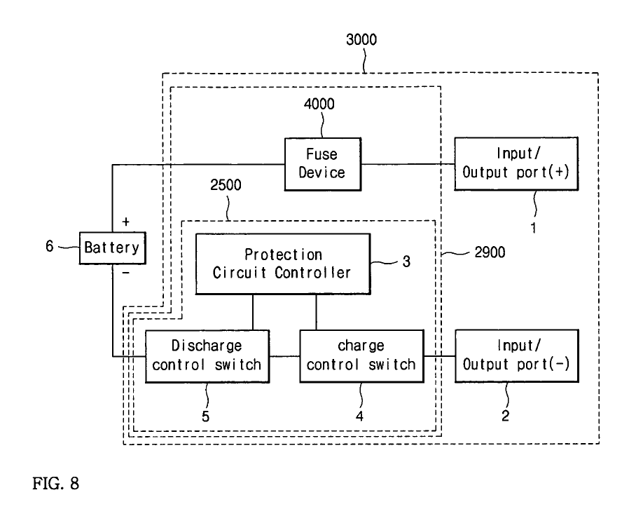

FIG. 8 is a block diagram showing an example of a fuse device for a lithium-ion battery according to one of the embodiments of the present invention used in a charge/discharge controller for a lithium-ion battery. The protection circuit board 3000 for the lithium-ion battery 6 includes a charge/discharge controller 2900. The charge/discharge controller 2900 includes the fuse device 4000. This fuse device 4000 may use any of the embodiments 10,11, 12 of the fuse devices shown in FIGS. 4, 5, or 6. The fuse device 4000 is located between the positive input/output port 1 and one electrode of the battery 6. The charge/discharge controller 2900 includes a switching control circuit 2500 having a charge control switch 4 and a discharge control switch 5 that are located between the negative input/output port 2 and the other electrode of the battery 6, and a protection circuit controller 3 for controlling the charge and discharge control switches 4, 5. When the battery 6 is in a charge mode, the charge/discharge controller 2900 controls the charge control switch 4 to charge the battery 6. When the battery 6 is in a discharge mode, the charge/discharge controller 2900 controls the discharge control switch 5 to discharge the battery 6.

While the present invention has been particularly shown and described with reference to exemplary embodiments thereof, it will be understood by those skilled in the art that various changes in form and details may be made therein without departing from the spirit and scope of the present invention as defined by the appended claims.

1. A fuse device for a lithium-ion battery, the fuse device comprising a weak circuit portion between an external input/output port and a bare cell, the weak circuit portion being formed as a part of a conductive pattern on a circuit board.

2. The fuse device of claim 1, wherein the weak circuit portion is formed as a step shaped portion of the conductive pattern.

3. The fuse device of claim 1, wherein the weak circuit portion is formed as a repeated step shaped portion of the conductive pattern.

4. The fuse device of claim 1, wherein the weak circuit portion is formed as a pinched portion of the conductive pattern.

5. The fuse device of claim 1, wherein the weak circuit portion is formed from a material different from a material of other parts of the conductive pattern.

6. The fuse device of claim 1, wherein the weak circuit portion has a shape adapted to generate ohmic heat upon a current passing through the weak circuit portion, the ohmic heat being capable of disconnecting the weak current portion from the conductive pattern.

7. The fuse device of claim 1, wherein the weak circuit portion has a width of 0.6 mm or less.

8. The fuse device of claim 1, wherein the weak circuit portion is formed from a metal having a high specific resistance

9. The fuse device of claim 1, wherein the weak circuit portion is formed from a heat-vulnerable metal or alloy.

10. A protection circuit board for a lithium-ion battery having a positive terminal and a negative terminal, the protection circuit board comprising:
a positive inpuvoutput port;
a negative inpuvoutput port; and
a charge/discharge controller for controlling the charging and discharging of the lithium-ion battery, the charge/discharge controller coupling the battery between the positive input/output port and the negative input/output port, the charge/discharge controller including a fuse device coupled between the positive input/output port and the positive terminal of the lithium-ion battery, and the fuse device being formed from a weak circuit portion in a conductive pattern formed on the protection circuit board;
wherein the negative inpuvoutput port is coupled to the negative terminal of the lithium-ion battery through a switching control circuit.

11. The protection circuit board of claim 10, wherein the switching control circuit includes:
a discharge control switch;
a charge control switch coupled to the discharge control switch, the discharge control switch and the charge control switch being located between the negative input/output port and the lithium-ion battery and coupled to the negative input/output port and to the lithium-ion battery; and
a protection circuit controller for controlling the charge control switch and the discharge control switch.

12. The protection circuit board of claim 10, wherein the fuse device is formed with a step pattern.

13. The protection circuit board of claim 10, wherein the fuse device is formed with a repeated step pattern.

14. The protection circuit board of claim 10, wherein the fuse device is formed with a pinched pattern.

15. The protection circuit board of claim 10, wherein the fuse device is formed from a heat-vulnerable conductive material.

16. A lithium-ion battery comprising:
a bare cell; and
a protection circuit board formed on a printed circuit board, the protection circuit board being coupled to the bare cell,
wherein the protection circuit board includes a fuse device formed from a weak circuit portion of the printed circuit board.

17. The lithium-ion battery of claim 18, wherein the weak circuit portion generates ohmic heat.

18. The lithium-ion battery of claim 16, wherein the weak circuit portion is a step pattern.

19. The lithium-ion battery of claim 16, wherein the weak circuit portion is a repeated step pattern.

20. The lithium-ion battery of claim 16, wherein the weak circuit portion is a pinched pattern.
